(19) United States
(12) Patent Application Publication
(10) Pub. No.: US 2026/0187249 A1
(43) Pub. Date: Jul. 2, 2026

(54) CHIPLET SYSTEM HAVING A PLURALITY OF CHIPLETS AND SECURE BOOTING METHOD THEREOF

(71) Applicant: REBELLIONS INC., Seongnam-si (KR)

(72) Inventor: Myunghoon CHOI, Seongnam-si (KR)

(21) Appl. No.: 19/439,243

(22) Filed: Jan. 2, 2026

(30) Foreign Application Priority Data
Jan. 2, 2025 (KR) 10-2025-0000170

(51) Int. Cl. G06F 21/57; G06F 1/08; G06F 13/42

(52) U.S. Cl. CPC G06F 21/575; G06F 1/08; G06F 13/4282

(57) ABSTRACT

A chiplet system including a plurality of chiplets is disclosed. The chiplet system includes a first chiplet including a ROM in which a first boot firmware is stored and a first processor, the first chiplet being connected to a non-volatile memory in which a second boot firmware is stored, a second chiplet including an RoT and a second processor, a first interface connecting the first chiplet and the second chiplet, and a second interface connecting the first chiplet and the second chiplet, the second interface having a lower communication speed than the first interface.

### CROSS-REFERENCE TO RELATED APPLICATION

The present application claims priority to and the benefit of Korean Application No. 10-2025-0000170, filed on Jan. 2, 2025, in the Korean Intellectual Property Office, the entire disclosure of which is incorporated by reference herein.

### BACKGROUND

### Field

Aspects of some embodiments relate to a chiplet system including a plurality of chiplets and a secure booting method thereof.

### Description of the Related Art

As demand for high performance and miniaturization of semiconductor devices and electronic products using the semiconductor devices increases, development of various package technologies related to the semiconductor devices is being carried out. As part of development of such technologies, package technology using chiplets has recently emerged.

A chiplet system may refer to a system in which chips performing various functions are not configured on a single die (or substrate), but rather are configured in functional units in each of a plurality of dies (chiplets) and packaged as a whole. Specifically, the chiplet system was developed to overcome the limitations of existing monolithic chips, and the dies within a package can be connected through a silicon interposer and can communicate according to a die-to-die communication standard such as universal chiplet interconnect express (UCIe).

Because such chiplets can be miniaturized by being divided into functional units, a size limit of a reticle, which is a template for printing a circuit on a surface of a wafer using light in a photo process of semiconductor manufacturing, may be overcome. In addition, because a yield of semiconductor manufacturing tends to be inversely proportional to an area, in a case of using chiplets, the yield of semiconductor manufacturing may be increased and manufacturing costs may be reduced. Accordingly, demand for using chiplets when manufacturing electronic products has recently increased, and technology development for a secure booting method of a chiplet system including a plurality of chiplets is also required.

### SUMMARY

The present disclosure provides a chiplet system including a plurality of chiplets and a secure booting method thereof to solve the problems described above.

The present disclosure can be implemented in various ways including a method, an apparatus (system), and/or a computer program stored in a computer-readable storage medium.

In some embodiments, a chiplet system may include a plurality of chiplets, the chiplet system may include a first chiplet including a ROM (read-only memory) in which a first boot firmware is stored and a first processor, the first chiplet being connected to a non-volatile memory in which a second boot firmware is stored, a second chiplet including an RoT (root of trust) in which immutable data is stored and a second processor, a first interface connecting the first chiplet and the second chiplet, and a second interface connecting the first chiplet and the second chiplet, a communication speed of the second interface being set lower than a communication speed of the first interface, wherein the first processor is configured to execute the first boot firmware, wherein if the first boot firmware is executed, the first boot firmware is configured to load the second boot firmware from the non-volatile memory, and set a register included in the first chiplet to indicate that the second boot firmware is loaded, wherein the RoT is configured to identify a setting of the register through the second interface, verify the second boot firmware if the second boot firmware is determined to be loaded based on the setting of the register, and notify the first processor that verification of the second boot firmware is completed if the verification of the second boot firmware is completed, and wherein if notified that the verification of the second boot firmware is completed, the first processor is further configured to execute the second boot firmware.

In some embodiments, the non-volatile memory further stores a third boot firmware, wherein the first chiplet further includes a first mailbox, wherein the second chiplet further includes a second mailbox, wherein if the second boot firmware is executed, the second boot firmware is configured to perform initial hardware setting, load the third boot firmware from the non-volatile memory, and request verification of the third boot firmware using the second mailbox through the second interface, wherein in response to requesting the verification of the third boot firmware, the RoT is further configured to verify the third boot firmware, and if verification of the third boot firmware is completed, notify that the verification of the third boot firmware is completed using the first mailbox through the second interface, and wherein if notified that the verification of the third boot firmware is completed, the first processor is further configured to execute the third boot firmware.

In some embodiments, the initial hardware setting includes a phase-locked loop (PLL) setting for adjusting a clock frequency.

In some embodiments, the non-volatile memory further stores a fourth firmware associated with connection setting between chiplets, wherein if the third boot firmware is executed, the third boot firmware is configured to load the fourth firmware from the non-volatile memory, and request verification of the fourth firmware using the second mailbox through the second interface, wherein in response to requesting the verification of the fourth firmware, the RoT is further configured to verify the fourth firmware, and if verification of the fourth firmware is completed, notify that the verification of the fourth firmware is completed using the first mailbox through the second interface, wherein if notified that the verification of the fourth firmware is completed, the third boot firmware is further configured to control a core associated with the first interface to initialize the first interface, wherein if initialization of the first interface is completed, the core is configured to notify the first processor that the initialization of the first interface is completed using the first mailbox, and wherein the third boot firmware is further configured to notify that the initialization of the first interface is completed using the second mailbox through the second interface.

In some embodiments, if notified that the initialization of the first interface is completed, the second processor is configured to perform a health check of the first interface, and if the health check of the first interface is completed, notify that the health check of the first interface is completed using the first mailbox through the second interface, and wherein if notified that the health check of the first interface is completed, the third boot firmware is further configured to perform a health check of the first interface, and if the health check of the first interface is completed, notify that the health check of the first interface is completed using the second mailbox through the second interface.

In some embodiments, the non-volatile memory further stores a fifth firmware associated with performance of a predetermined function or application, wherein if the first interface is activated, the third boot firmware is further configured to load the fifth firmware from the non-volatile memory, and request verification of the fifth firmware using the second mailbox through the first interface, wherein in response to requesting the verification of the fifth firmware, the RoT is further configured to verify the fifth firmware, and if verification of the fifth firmware is completed, notify that the verification of the fifth firmware is completed using the first mailbox through the first interface, and wherein if notified that the verification of the fifth firmware is completed, the first processor is further configured to execute the fifth firmware.

In some embodiments, the chiplet system further includes a third interface connecting the second chiplet and a host device, wherein the RoT is further configured to activate the third interface before identifying the setting of the register.

In some embodiments, the chiplet system further includes a third interface connecting the first chiplet and a host device, wherein the non-volatile memory further stores a sixth firmware associated with connection setting with the host device, wherein the first boot firmware is further configured to set the register to indicate that the third interface is in a standby state before loading the second boot firmware, wherein the RoT is further configured to identify the setting of the register through the second interface, perform clock setting of the first chiplet if the third interface is determined to be in the standby state based on the setting of the register, load the sixth firmware from the non-volatile memory, and verify the sixth firmware, if verification of the sixth firmware is completed, control a core associated with the third interface to initialize the third interface, and wherein if initialization of the third interface is completed, the core is configured to notify the RoT that the initialization of the third interface is completed using a mailbox included in the second chiplet through the second interface.

In some embodiments, the third interface includes a peripheral component interconnect express (PCIe) interface.

In some embodiments, the first interface includes a universal chiplet interconnect express (UCIe) interface, and the second interface includes a serial peripheral interface (SPI) interface.

In some embodiments, a chiplet system may include a plurality of chiplets, the chiplet system may include a first chiplet including a ROM (read-only memory) in which a first boot firmware is stored and a first processor, a second chiplet including an RoT (root of trust) in which immutable data is stored and a second processor, the second chiplet being connected to a non-volatile memory in which a second boot firmware is stored, a first interface connecting the first chiplet and the second chiplet, and a second interface connecting the first chiplet and the second chiplet, a communication speed of the second interface being set lower than a communication speed of the first interface, wherein the first processor is configured to execute the first boot firmware, wherein if the first boot firmware is executed, the first processor is further configured to set a register included in the first chiplet to indicate that the second boot firmware is in a standby state, wherein the RoT is configured to identify a setting of the register through the second interface, load the second boot firmware from the non-volatile memory into the first chiplet if the second boot firmware is determined to be in the standby state based on the setting of the register, verify the second boot firmware, and notify the first processor that verification of the second boot firmware is completed if the verification of the second boot firmware is completed, and wherein if notified that the verification of the second boot firmware is completed, the first processor is further configured to execute the second boot firmware.

In some embodiments, the non-volatile memory further stores a third boot firmware, wherein the first chiplet further includes a first mailbox, wherein the second chiplet further includes a second mailbox, wherein if the second boot firmware is executed, the second boot firmware is configured to perform initial hardware setting, and request loading and verification of the third boot firmware using the second mailbox through the second interface, wherein in response to requesting the loading and verification of the third boot firmware, the RoT is further configured to load the third boot firmware from the non-volatile memory into the first chiplet, verify the third boot firmware, and if verification of the third boot firmware is completed, notify that the verification of the third boot firmware is completed using the first mailbox through the second interface, and wherein if notified that the verification of the third boot firmware is completed, the first processor is further configured to execute the third boot firmware.

In some embodiments, the non-volatile memory further stores a fourth firmware associated with connection setting between chiplets, wherein if the third boot firmware is executed, the third boot firmware is configured to request loading and verification of the fourth firmware using the second mailbox through the second interface, wherein in response to requesting the loading and verification of the fourth firmware, the RoT is further configured to load the fourth firmware from the non-volatile memory into the first chiplet, verify the fourth firmware, and if verification of the fourth firmware is completed, notify that the verification of the fourth firmware is completed using the first mailbox through the second interface, wherein if notified that the verification of the fourth firmware is completed, the third boot firmware is further configured to control a core associated with the first interface to initialize the first interface, wherein if initialization of the first interface is completed, the core is configured to notify the first processor that the initialization of the first interface is completed using the first mailbox, and wherein the third boot firmware is further configured to notify that the initialization of the first interface is completed using the second mailbox through the second interface.

In some embodiments, the non-volatile memory further stores a fifth firmware associated with performance of a predetermined function or application, wherein if the first interface is activated, the third boot firmware is further configured to request loading and verification of the fifth firmware using the second mailbox through the first interface, wherein in response to requesting the loading and verification of the fifth firmware, the RoT is further configured to load the fifth firmware from the non-volatile memory into the first chiplet, verify the fifth firmware, and if verification of the fifth firmware is completed, notify that the verification of the fifth firmware is completed using the first mailbox through the first interface, and wherein if notified that the verification of the fifth firmware is completed, the first processor is further configured to execute the fifth firmware.

In some embodiments, the chiplet system further includes a third interface connecting the first chiplet and a host device, wherein the non-volatile memory further stores a sixth firmware associated with connection setting with the host device, wherein the first boot firmware is further configured to set the register to indicate that the third interface is in a standby state before the register is set, wherein the RoT is further configured to identify the setting of the register through the second interface, perform clock setting of the first chiplet if the third interface is determined to be in the standby state based on the setting of the register, load the sixth firmware from the non-volatile memory into the first chiplet, and verify the sixth firmware, wherein if verification of the sixth firmware is completed, the RoT is configured to control a core associated with the third interface to initialize the third interface, and wherein if initialization of the third interface is completed, the core is configured to notify the RoT that the initialization of the third interface is completed using a mailbox included in the second chiplet through the second interface.

According to some embodiments of the present disclosure, stability and security for a system may be guaranteed by supporting secure booting of a chiplet not including an RoT using a chiplet including an RoT.

Effects of the present disclosure are not limited to the effects mentioned above, and other effects not mentioned will be clearly understood by those having ordinary knowledge in the technical field to which the present disclosure belongs (referred to as “those skilled in the art”) from the description of the claims.

### BRIEF DESCRIPTION OF THE DRAWINGS

Embodiments of the present disclosure will be described with reference to the accompanying drawings described below, wherein like reference numbers represent like elements, but are not limited thereto.

FIG. 1 illustrates a diagram for explaining a configuration of a chiplet system that performs secure booting of a chiplet connected to a non-volatile memory in which boot firmware is stored and a host device and not including an RoT, using a chiplet including an RoT according to an embodiment of the present disclosure.

FIG. 2 illustrates a diagram for explaining a configuration of a chiplet system in which a chiplet that is connected to a host device and including an RoT is used to perform a secure booting of another chiplet that is connected to a non-volatile memory storing boot firmware and does not include an RoT, according to an embodiment of the present disclosure.

FIG. 3 illustrates a diagram for explaining a configuration of a chiplet system that performs a secure booting of a chiplet that is connected to a host device and does not include an RoT, by using another chiplet including an RoT according to an embodiment of the present disclosure.

FIG. 4 illustrates a diagram for explaining a configuration of a chiplet system that performs secure booting of a chiplet not including an RoT, using a chiplet connected to a host device and including an RoT according to an embodiment of the present disclosure.

FIG. 5 illustrates a diagram for explaining a method of verifying and executing a second boot firmware during a secure booting process of a chiplet connected to a non-volatile memory in which boot firmware is stored and not including an RoT, using a chiplet including an RoT according to an embodiment of the present disclosure.

FIG. 6 illustrates a diagram for explaining a method of verifying and executing a third boot firmware during a secure booting process of a chiplet connected to a non-volatile memory in which boot firmware is stored and not including an RoT, using a chiplet including an RoT according to an embodiment of the present disclosure.

FIG. 7 illustrates a diagram for explaining a method of verifying and executing a fourth firmware associated with connection setting between chiplets during a secure booting process of a chiplet connected to a non-volatile memory in which boot firmware is stored and not including an RoT, using a chiplet including an RoT according to an embodiment of the present disclosure.

FIG. 8 illustrates a diagram for explaining a method of verifying and executing a fifth firmware associated with performance of a predetermined function or application during a secure booting process of a chiplet connected to a non-volatile memory in which boot firmware is stored and not including an RoT, using a chiplet including an RoT according to an embodiment of the present disclosure.

FIG. 9 illustrates a diagram for explaining a method of verifying and executing a second boot firmware during a secure booting process of a chiplet not including an RoT, using a chiplet connected to a non-volatile memory in which boot firmware is stored and including an RoT according to an embodiment of the present disclosure.

FIG. 10 illustrates a diagram for explaining a method of verifying and executing a third boot firmware during a secure booting process of a chiplet not including an RoT, using a chiplet connected to a non-volatile memory in which boot firmware is stored and including an RoT according to an embodiment of the present disclosure.

FIG. 11 illustrates a diagram for explaining a method of verifying and executing a fourth firmware associated with connection setting between chiplets during a secure booting process of a chiplet not including an RoT, using a chiplet connected to a non-volatile memory in which boot firmware is stored and including an RoT according to an embodiment of the present disclosure.

FIG. 12 illustrates a diagram for explaining a method of verifying and executing a fifth firmware associated with performance of a predetermined function or application during a secure booting process of a chiplet not including an RoT, using a chiplet connected to a non-volatile memory in which boot firmware is stored and including an RoT according to an embodiment of the present disclosure.

FIG. 13 illustrates a diagram for explaining a method of initializing an interface with a host device during a secure booting process of a chiplet connected to the host device and not including an RoT, using a chiplet including an RoT according to an embodiment of the present disclosure.

### DETAILED DESCRIPTION

Hereinafter, specific details for implementation of the present disclosure will be described in detail with reference to the accompanying drawings. However, in the following description, if there is a concern of unnecessarily obscuring the subject matter of the present disclosure, detailed descriptions of well-known functions or configurations will be omitted.

In the accompanying drawings, identical or corresponding components are given the same reference numerals. In addition, in the description of the following embodiments, redundant description of identical or corresponding components may be omitted. However, even if description of a component is omitted, it is not intended that such a component is not included in a certain embodiment.

Advantages and features of the disclosed embodiments and methods of achieving the advantages and features will become clear with reference to the embodiments described later in conjunction with the accompanying drawings. However, the present disclosure is not limited to the embodiments disclosed below but may be implemented in various different forms, and these embodiments are only provided to make the present disclosure complete and to fully inform those skilled in the art of the scope of the invention.

Terms used in this specification will be briefly described, and the disclosed embodiments will be described in detail. The terms used in this specification have selected general terms currently widely used as much as possible while considering functions in the present disclosure, but this may vary according to intentions of technicians engaged in the related field, precedents, or emergence of new technology. In addition, in specific cases, there are terms arbitrarily selected by the applicant, and in this case, meanings will be described in detail in the corresponding description part of the invention. Therefore, terms used in the present disclosure should be defined based on meanings of the terms and contents throughout the present disclosure, not simple names of the terms.

Singular expressions in this specification include plural expressions unless the context clearly specifies otherwise. In addition, plural expressions include singular expressions unless the context clearly specifies otherwise. Throughout the specification, if a part is said to include a component, this means that other components are not excluded but may further be included unless specifically stated otherwise.

In addition, the term ‘module’ or ‘unit’ used in the specification means a software or hardware component, and ‘module’ or ‘unit’ performs certain roles. However, ‘module’ or ‘unit’ is not limited to software or hardware. ‘Module’ or ‘unit’ may be configured to be in an addressable storage medium or may be configured to reproduce one or more processors. Therefore, as an example, ‘module’ or ‘unit’ may include at least one of components such as software components, object-oriented software components, class components, and task components, processes, functions, attributes, procedures, subroutines, segments of program code, drivers, firmware, microcode, circuits, data, databases, data structures, tables, arrays, or variables. Functions provided within the components and ‘modules’ or ‘units’ may be combined into a smaller number of components and ‘modules’ or ‘units’ or further separated into additional components and ‘modules’ or ‘units’.

According to an embodiment of the present disclosure, a ‘module’ or ‘unit’ may be implemented with a processor and a memory. A ‘processor’ should be interpreted broadly to include a general-purpose processor, a central processing unit (CPU), a microprocessor, a digital signal processor (DSP), a controller, a microcontroller, a state machine, and the like. In some environments, a ‘processor’ may also refer to an application-specific integrated circuit (ASIC), a programmable logic device (PLD), a field programmable gate array (FPGA), and the like. A ‘processor’ may refer to a combination of processing devices, such as, for example, a combination of a DSP and a microprocessor, a combination of a plurality of microprocessors, a combination of one or more microprocessors combined with a DSP core, or any other such combination of configurations. In addition, ‘memory’ should be interpreted broadly to include any electronic component capable of storing electronic information. ‘Memory’ may also refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage devices, registers, and the like. If a processor can read information from and/or write information to a memory, the memory is said to be in electronic communication with the processor. Memory integrated into a processor is in electronic communication with the processor.

In addition, terms such as first, second, A, B, (a), (b), etc. used in the following embodiments are only used to distinguish a component from other components, and essence, order, or sequence of the corresponding component is not limited by the terms.

In addition, in the following embodiments, if a component is described as being ‘connected’, ‘coupled’, or ‘joined’ to another component, the component may be directly connected or joined to the other component, but it should be understood that another component may be ‘connected’, ‘coupled’, or ‘joined’between each component.

In addition, ‘comprises’ and/or ‘comprising’ used in the following embodiments do not exclude existence or addition of one or more other components, steps, operations, and/or elements.

Hereinafter, various embodiments of the present disclosure will be described in detail according to the accompanying drawings.

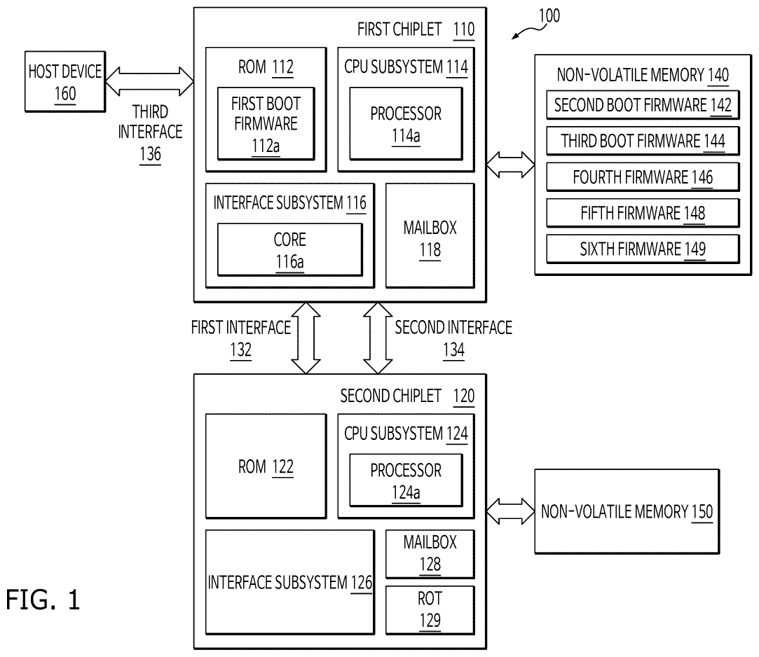

FIG. 1 illustrates a configuration of a chiplet system that performs secure booting of a chiplet connected to a non-volatile memory in which boot firmware is stored and a host device and not including an RoT, using a chiplet including an RoT according to an embodiment of the present disclosure. Referring to FIG. 1, a chiplet system 100 may include a plurality of chiplets 110 and 120. For example, the chiplet system 100 may include a first chiplet 110 and a second chiplet 120. However, the number of chiplets included in the chiplet system 100 is not limited thereto. According to various embodiments, the chiplet system 100 may further include at least one chiplet in addition to the chiplets described above. The chiplet system 100 including the plurality of chiplets 110 and 120 may be packaged, and accordingly may be referred to as a packaging device.

The chiplet system 100 may include a homogeneous chiplet system configured by connecting several chiplets performing the same structure or function, or a heterogeneous chiplet system in which at least one of the plurality of chiplets includes a chiplet performing a different structure or function. In a case of a heterogeneous chiplet system, an optimized design can be implemented by allocating hardware resources suitable for a purpose of the chiplet. For example, in a case where a separate chiplet in charge of an input/output function in the entire chiplet system is included, an interface (e.g., a peripheral component interconnect express (PCIe) interface or an Ethernet interface) for communication with a host device 160 may be removed or not included in a chiplet in charge of a computing function (e.g., neural network computing), so optimization for hardware resources may be possible from a perspective of the entire chiplet system. In the following description, a case where the chiplet system 100 is configured as a system including at least one heterogeneous chiplet will be described. More specifically, a configuration for secure booting in a heterogeneous chiplet system in which an RoT is not included in the first chiplet 110 and an RoT 129 is included in the second chiplet 120 will be described.

The plurality of chiplets 110 and 120 included in the chiplet system 100 may be connected to each other through a first interface 132. For example, the first chiplet 110 and the second chiplet 120 may be connected through the first interface 132. According to an embodiment, the first interface 132 may be referred to as a die-to-die interface, and for example, may include UCIe or the like.

According to an embodiment, the plurality of chiplets 110 and 120 included in the chiplet system 100 may be connected to each other through a second interface 134. For example, the first chiplet 110 and the second chiplet 120 may be connected through the second interface 134. According to an embodiment, the second interface 134 is a backup interface, and a communication speed of data may be set lower than the first interface 132 for connection between chiplets. For example, the second interface 134 may include interfaces such as secure joint test action group (secure jtag), general purpose input/output (GPIO), inter integrated circuit (I2C), and the like. In addition, the second interface 134 may be utilized for input/output communication with an outside of the chiplet. For example, the second interface 134 may include serial peripheral interface (SPI), universal asynchronous receiver/transmitter (UART), and the like.

Any one chiplet (e.g., the first chiplet 110) among the plurality of chiplets 110 and 120 included in the chiplet system 100 may be connected to the host device 160 (or an external electronic device) through a third interface 136. At the same time, communication of the remaining chiplet (e.g., the second chiplet 120) with the host device 160 may be limited. For example, in a heterogeneous chiplet system, the first chiplet 110 may be in charge of an input/output function with the host device 160, and the second chiplet 120 may be in charge of other functions (e.g., a computing function or a memory expansion function, etc.) except for the input/output function. According to an embodiment, chiplets (e.g., the second chiplet 120) remaining after excluding the first chiplet 110 in charge of the input/output function may be homogeneous chiplets having the same structure and function as each other, or may be heterogeneous chiplets in which at least one has a different structure or a different function. According to an embodiment, the third interface 136 may be referred to as a host interface, and for example, may include PCIe, Ethernet, compute express link (CXL) Interface, and the like.

If power is supplied and signals associated with booting (e.g., a boot signal, a reset signal, etc.) are received, the chiplet system 100 may perform a secure booting process. The secure booting process may represent a process for strengthening security of the chiplet system 100 by verifying integrity of a program or software to be executed. For example, in the secure booting process, the chiplet system 100 may verify integrity of boot firmware (e.g., the first boot firmware 112a, the second boot firmware 142, and the third boot firmware 144), and may proceed with (or perform) a booting process based on the boot firmware only if integrity verification is successful. Here, the first boot firmware 112a, the second boot firmware 142, and the third boot firmware 144 may be executed in stages. For example, the first boot firmware 112a may represent a zero stage bootloader (ZSBL), the second boot firmware 142 may represent a first stage bootloader (FSBL), and the third boot firmware 144 may represent a second stage bootloader (SSBL). A security algorithm used for integrity check may include a public-key cryptography (PKC) scheme (e.g., ECDSA-384) and a hash algorithm (e.g., SHA-384). For example, a result of a hash operation on firmware may be encrypted through PKC to generate a signature and stored with the firmware. In addition, the integrity check may be performed in a way that the RoT recalculates a hash of the firmware and compares the hash with a result obtained by decrypting the signature stored with the firmware. Here, the RoT may manage an entire flow of the secure booting process. For example, the RoT may allow only firmware code that has passed the integrity check to be operable in the system, and if the integrity check fails, the RoT may stably drive the system through a recovery process.

The chiplets 110 and 120 included in the chiplet system 100 may include a read-only memory (ROM) 112 and 122 in which first boot firmware (e.g., the first boot firmware 112a) is stored, a CPU subsystem 114 and 124 including a processor 114a and 124a, an interface subsystem 116 and 126, and a mailbox 118 and 128. However, configurations of the chiplets 110 and 120 are not limited thereto. According to various embodiments, the chiplets 110 and 120 may omit at least one of the components described above, and may further include at least one other component. In addition, FIG. 1 shows a configuration associated with the secure booting process of the first chiplet 110, and although not shown, a configuration associated with the secure booting process of the second chiplet 120 may be included in the second chiplet 120. For example, the first boot firmware may be stored in the ROM 122, and the interface subsystem 126 may include a core. Furthermore, a non-volatile memory 150 connected to the second chiplet 120 may include at least one of the second boot firmware, the third boot firmware, the fourth firmware associated with connection setting between chiplets, or the fifth firmware associated with performance of a predetermined function or application.

The CPU subsystems 114 and 124 may include a CPU (e.g., the processor 114a and 124a) for driving general-purpose firmware. The interface subsystems 116 and 126 are dedicated modules for interfaces, and may include a core (e.g., the core 116a) that performs processing of data associated with the interfaces. The interface subsystems 116 and 126 may include at least one of a UCIe subsystem corresponding to an interface for connection between chiplets 110 and 120 or a PCIe subsystem corresponding to an interface for connection with the host device 160. The mailboxes 118 and 128 may perform a function of message delivery or notification between the chiplets 110 and 120 or inside the chiplets 110 and 120. For example, if a transmission core writes a message in the mailboxes 118 and 128, the mailboxes 118 and 128 may inform that the message has arrived by generating an interrupt to a reception core.

The chiplets 110 and 120 included in the chiplet system 100 may be connected to non-volatile memories 140 and 150 in which firmware is stored. For example, the chiplets 110 and 120 may be connected to the non-volatile memories 140 and 150 through an SPI interface. The non-volatile memories 140 and 150 may include at least one of the second boot firmware 142, the third boot firmware 144, the fourth firmware 146 associated with connection setting between chiplets 110 and 120 (e.g., UCIe firmware), the fifth firmware 148 associated with the performance of a predetermined function or application (e.g., application firmware), or the sixth firmware 149 associated with connection setting with the host device 160 (e.g., PCIe firmware). Because the non-volatile memories 140 and 150 may be tampered with, the RoT 129 may perform an integrity check before the firmware stored in the non-volatile memories 140 and 150 is executed during the secure booting process. According to an embodiment, the non-volatile memories 140 and 150 may include flash memory.

The second chiplet 120 may include a root of trust (RoT) 129. The RoT 129 may perform integrity verification for firmware operating in the chiplets 110 and 120 and/or real-time integrity verification for at least some data being used in the chiplets 110 and 120. For such security functions, the RoT 129 may include immutable data. Here, the immutable data may include an encryption key (or a security key), security data (e.g., a hash value), and the like, and the RoT 129 may manage a secure process of the chiplets 110 and 120. For example, the RoT 129 may control so that only programs (e.g., firmware) and data that have succeeded in integrity verification can be operated and processed in the chiplets 110 and 120, and if integrity verification fails (e.g., if tampering of programs and/or data is confirmed), the RoT 129 may safely drive the chiplet system 100 through a recovery process.

Looking at a secure booting process of the first chiplet 110 using the RoT 129 of the second chiplet 120, the processor (hereinafter referred to as a first processor) 114a of the first chiplet 110 may execute the first boot firmware 112a. Then, if the first boot firmware 112a is executed, the first boot firmware 112a may load the second boot firmware 142 from the non-volatile memory 140, and set a register (not shown) included in the first chiplet 110 to indicate that the second boot firmware 142 is loaded.

The RoT 129 may identify a setting of the register through the second interface 134. Based on the setting of the register, if it is determined that the second boot firmware 142 has been loaded, the RoT 129 may verify the second boot firmware 142, and upon completion of the verification of the second boot firmware 142, the RoT 129 may notify the first processor 112a that the verification of the second boot firmware 142 is completed. Then, if notified that the verification of the second boot firmware 142 is completed, the first processor 112a may execute the second boot firmware 142.

If the second boot firmware 142 is executed, the second boot firmware 142 may perform initial hardware setting. For example, the second boot firmware 142 may perform a phase-locked loop (PLL) setting for adjusting a clock frequency. The PLL may include a circuit for frequency adjustment/control and timing synchronization of a clock signal. For example, the PLL may include a circuit capable of synchronizing a frequency of an internal clock signal provided by the chiplets 110 and 120 with an external timing signal. According to an embodiment, as the second boot firmware 142 performs a PLL control operation to increase the clock frequency, the chiplets 110 and 120 may be capable of high-speed operation.

Then, the second boot firmware 142 may load the third boot firmware 144 from the non-volatile memory 140, and request verification of the third boot firmware 144 using a mailbox (hereinafter referred to as a second mailbox) 128 of the second chiplet 120 through the second interface 134.

In response to requesting the verification of the third boot firmware 144, the RoT 129 may verify the third boot firmware 144. In addition, if the verification of the third boot firmware 144 is completed, the RoT 129 may notify that the verification of the third boot firmware 144 is completed using a mailbox (hereinafter referred to as a first mailbox) 118 of the first chiplet 110 through the second interface 134. Then, if notified that the verification of the third boot firmware 144 is completed, the first processor 114a may execute the third boot firmware 144.

If the third boot firmware 144 is executed, the third boot firmware 144 may load the fourth firmware 146 from the non-volatile memory 140, and request verification of the fourth firmware 146 using the second mailbox 128 through the second interface 134.

In response to requesting the verification of the fourth firmware 146, the RoT 129 may verify the fourth firmware 146. In addition, if the verification of the fourth firmware 146 is completed, the RoT 129 may notify that the verification of the fourth firmware 146 is completed using the first mailbox 118 through the second interface 134.

If notified that the verification of the fourth firmware 146 is completed, the third boot firmware 146 may control the core 116a associated with the first interface 132 to initialize the first interface 132. Then, if initialization of the first interface 132 is completed, the core 116a may notify the first processor 112a that the initialization of the first interface 132 is completed by using the first mailbox 118. In addition, the third boot firmware 144 may notify that the initialization of the first interface 132 is completed via the second mailbox 128 through the second interface 134.

If notified that the initialization of the first interface 132 is completed, the processor (hereinafter referred to as a second processor) 124a of the second chiplet 120 may perform a health check of the first interface 132. In addition, if the health check of the first interface 132 is completed, the second processor 124a may notify that the health check of the first interface 132 is completed using the first mailbox 118 through the second interface 134.

If notified that the health check of the first interface 132 is completed, the third boot firmware 144 may perform a health check of the first interface 132. In addition, if the health check of the first interface 132 is completed, the third boot firmware 144 may notify that the health check of the first interface 132 is completed using the second mailbox 128 through the second interface 134.

Then, if the first interface 132 is activated, the third boot firmware 144 may load the fifth firmware 148 from the non-volatile memory 140, and request verification of the fifth firmware 148 using the second mailbox 128 through the first interface 132.

In response to requesting the verification of the fifth firmware 148, the RoT 129 may verify the fifth firmware 148. In addition, if verification of the fifth firmware 148 is completed, the RoT 129 may notify that the verification of the fifth firmware 148 is completed using the first mailbox 118 through the first interface 132. If notified that the verification of the fifth firmware 148 is completed, the first processor 114a may execute the fifth firmware 148.

According to an embodiment, the first boot firmware 112a may be configured to set a register included in the first chiplet 110 to indicate that the third interface 136 is in a standby state before loading the second boot firmware 142. The RoT 129 may be configured to identify the setting of the register through the second interface 134. Then, based on the setting of the register, if the third interface 136 is determined to be in the standby state, the RoT 129 may be configured to perform clock setting of the first chiplet 110. In addition, the RoT 129 may load the sixth firmware 149 from the non-volatile memory 140, and verify the sixth firmware 149. Then, if verification of the sixth firmware 149 is completed, the RoT 129 may control the core 116a associated with the third interface 136 to initialize the third interface 136. Then, if initialization of the third interface 136 is completed, the core 116a may notify the RoT 129 that the initialization of the third interface 136 is completed using the second mailbox 128 through the second interface 134. Then, the secure booting process described above may be performed. For example, in a configuration where the host device 160 is connected to the first chiplet 110, an activation process of the third interface 136 (e.g., a PCIe interface enable process) may be preferentially performed to satisfy a boot-up time requirement.

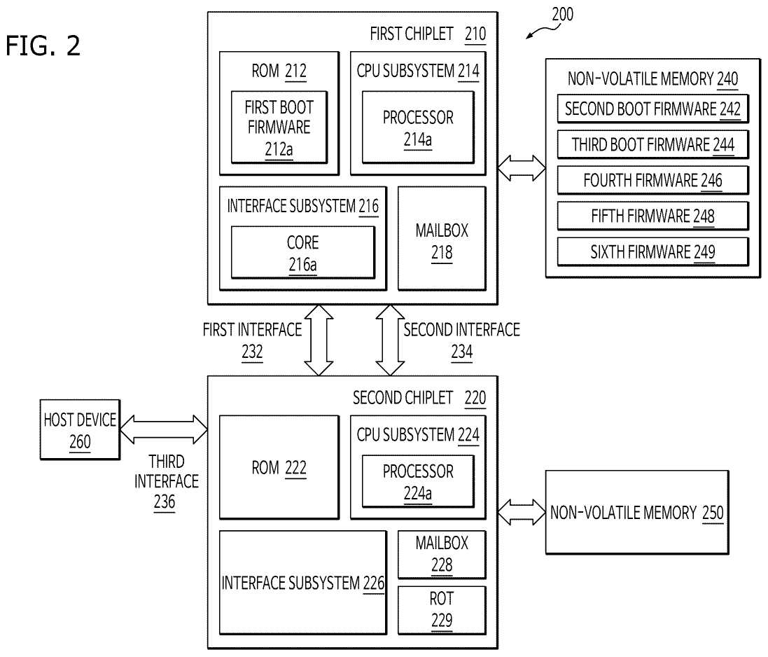

FIG. 2 illustrates a diagram for expelling a configuration of a chiplet system that performs secure booting of a chiplet connected to a non-volatile memory in which boot firmware is stored and not including an RoT, using a chiplet connected to a host device and including an RoT according to an embodiment of the present disclosure. A chiplet system 200 shown in FIG. 2 may be identical or similar to the chiplet system 100 shown in FIG. 1, except that a host device 260 (e.g., the host device 160 of FIG. 1) is connected to a second chiplet 220 (e.g., the second chiplet 120 of FIG. 1) rather than a first chiplet 210 (e.g., the first chiplet 110 of FIG. 1). Accordingly, descriptions for configurations identical or similar to those described with reference to FIG. 1 will be omitted, and a configuration for secure booting in a heterogeneous chiplet system in which an RoT is not included in the first chiplet 210 and an RoT 229 is included in the second chiplet 220 will be described.

The configurations of chiplets 210 and 220 shown in FIG. 2 may be identical or similar to configurations of the chiplets 110 and 120 shown in FIG. 1. For example, the chiplets 210 and 220 may include ROMs 212 and 222 in which first boot firmware (e.g., the first boot firmware 212a) is stored, CPU subsystems 214 and 224 including processors 214a and 224a, interface subsystems 216 and 226, and mailboxes 218 and 228. In addition, the chiplets 210 and 220 may be connected to non-volatile memories 240 and 250 in which firmware is stored. In addition, the second chiplet 220 may include an RoT 229. In addition, FIG. 2 shows a configuration associated with the secure booting process of the first chiplet 210, and although not shown, a configuration associated with the secure booting process of the second chiplet 220 may be also included in the second chiplet 220. For example, the first boot firmware may be stored in the ROM 222, and the interface subsystem 226 may include a core. Furthermore, a non-volatile memory 250 connected to the second chiplet 220 may include at least one of the second boot firmware, the third boot firmware, the fourth firmware associated with connection setting between chiplets, or the fifth firmware associated with the performance of a predetermined function or application.

Looking at a secure booting process of the first chiplet 210 using the RoT 229 of the second chiplet 220, the processor (hereinafter referred to as a first processor) 214a of the first chiplet 210 may execute the first boot firmware 212a. Then, if the first boot firmware 212a is executed, the first boot firmware 212a may load the second boot firmware 242 from the non-volatile memory 240, and set a register (not shown) included in the first chiplet 210 to indicate that the second boot firmware 242 is loaded.

The RoT 229 may identify a setting of the register through a second interface 234. If the second boot firmware 242 is determined to be loaded based on the setting of the register, the RoT 229 may verify the second boot firmware 242, and if verification of the second boot firmware 242 is completed, the RoT 229 may notify the first processor 212a that the verification of the second boot firmware 242 is completed. Then, if notified that the verification of the second boot firmware 242 is completed, the first processor 212a may execute the second boot firmware 242.

If the second boot firmware 242 is executed, the second boot firmware 242 may perform initial hardware setting. For example, the second boot firmware 242 may perform a PLL setting for adjusting a clock frequency.

Then, the second boot firmware 242 may load the third boot firmware 244 from the non-volatile memory 240, and request verification of the third boot firmware 244 using a mailbox (hereinafter referred to as a second mailbox) 228 of the second chiplet 220 through the second interface 234.

In response to requesting the verification of the third boot firmware 244, the RoT 229 may verify the third boot firmware 244. In addition, if verification of the third boot firmware 244 is completed, the RoT 229 may notify that the verification of the third boot firmware 244 is completed using a mailbox (hereinafter referred to as a first mailbox) 218 of the first chiplet 210 through the second interface 234. Then, if notified that the verification of the third boot firmware 244 is completed, the first processor 214a may execute the third boot firmware 244.

If the third boot firmware 244 is executed, the third boot firmware 244 may load a fourth firmware 246 (e.g., UCIe firmware) associated with connection setting between the chiplets 210 and 220 from the non-volatile memory 240, and request verification of the fourth firmware 246 using the second mailbox 228 through the second interface 234.

In response to requesting the verification of the fourth firmware 246, the RoT 229 may verify the fourth firmware 246. In addition, if verification of the fourth firmware 246 is completed, the RoT 229 may notify that the verification of the fourth firmware 246 is completed using the first mailbox 218 through the second interface 234.

If notified that the verification of the fourth firmware 246 is completed, the third boot firmware 244 may control a core 216a associated with a first interface 232 to initialize the first interface 232. Then, if initialization of the first interface 232 is completed, the core 216a may notify the first processor 214a that the initialization of the first interface 232 is completed by using the first mailbox 218. In addition, the third boot firmware 244 may notify that the initialization of the first interface 232 is completed using the second mailbox 228 through the second interface 234.

If notified that the initialization of the first interface 232 is completed, the processor 224a (hereinafter referred to as a second processor) of the second chiplet 220 may perform a health check of the first interface 232. In addition, if the health check of the first interface 232 is completed, the second processor 224a may notify that the health check of the first interface 232 is completed using the first mailbox 218 through the second interface 234.

If notified that the health check of the first interface 232 is completed, the third boot firmware 244 may perform a health check of the first interface 232. In addition, if the health check of the first interface 232 is completed, the third boot firmware 244 may notify that the health check of the first interface 232 is completed using the second mailbox 228 through the second interface 234.

Then, if the first interface 232 is activated, the third boot firmware 244 may load a fifth firmware 248 (e.g., application firmware) associated with performance of a predetermined function or application from the non-volatile memory 240, and request verification of the fifth firmware 248 using the second mailbox 228 through the first interface 232.

In response to requesting the verification of the fifth firmware 248, the RoT 229 may verify the fifth firmware 248. In addition, if verification of the fifth firmware 248 is completed, the RoT 229 may notify that the verification of the fifth firmware 248 is completed using the first mailbox 218 through the first interface 232. If notified that the verification of the fifth firmware 248 is completed, the first processor 214a may execute the fifth firmware 248.

According to an embodiment, the RoT 229 may be configured to activate a third interface 236 before identifying a setting of a register included in the first chiplet 210. For example, in a configuration where the host device 260 is connected to the second chiplet 220, an activation process of the third interface 236 may be preferentially performed to satisfy the boot-up time requirement.

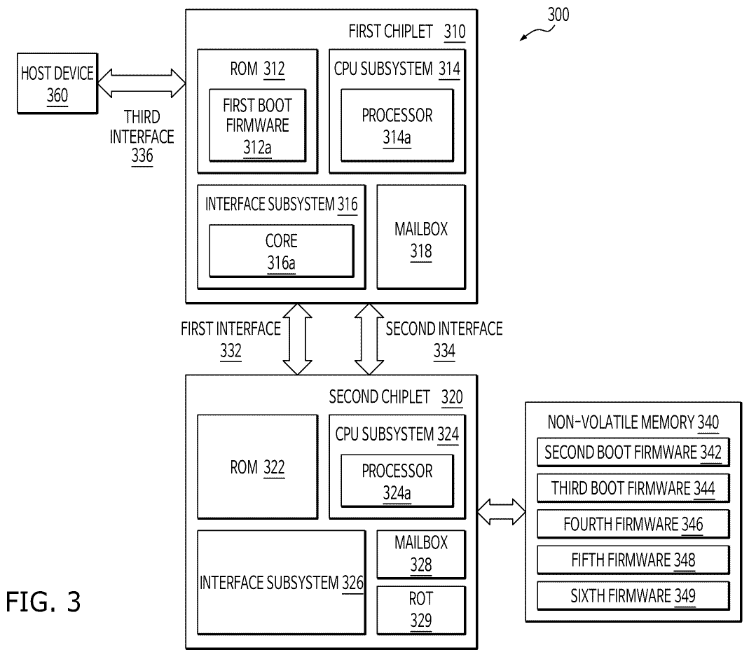

FIG. 3 illustrates a configuration of a chiplet system that performs secure booting of a chiplet connected to a host device and not including an RoT, using a chiplet including an RoT according to an embodiment of the present disclosure. A chiplet system 300 shown in FIG. 3 may be identical or similar to the chiplet system 100 shown in FIG. 1, except that a non-volatile memory 340 in which firmware is stored is not connected to a first chiplet 310 (e.g., the first chiplet 110 of FIG. 1) but connected only to a second chiplet 320 (e.g., the second chiplet 120 of FIG. 1). Accordingly, descriptions for configurations identical or similar to those described with reference to FIG. 1 will be omitted, and a configuration for secure booting in a heterogeneous chiplet system in which an RoT is not included in the first chiplet 310 and an RoT 329 is included in the second chiplet 320 will be described.

The configurations of chiplets 310 and 320 shown in FIG. 3 may be identical or similar to the configurations of the chiplets 110 and 120 shown in FIG. 1. For example, the chiplets 310 and 320 may include ROMs 312 and 322 in which first boot firmware (e.g., first boot firmware 312a) is stored, CPU subsystems 314 and 324 including processors 314a and 324a, interface subsystems 316 and 326, and mailboxes 318 and 328. In addition, the second chiplet 320 may be connected to the non-volatile memory 340 in which firmware is stored, and may include an RoT 329. In addition, FIG. 3 shows a configuration associated with the secure booting process of the first chiplet 310, and although not shown, a configuration associated with the secure booting process of the second chiplet 320 may be included in the second chiplet 320. For example, the first boot firmware may be stored in the ROM 322, and the interface subsystem 326 may include a core.

Looking at a secure booting process of the first chiplet 310 using the RoT 329 of the second chiplet 320, the processor (hereinafter referred to as a first processor) 314a of the first chiplet 310 may execute the first boot firmware 312a. Then, if the first boot firmware 312a is executed, the first boot firmware 312a may set a register (not shown) included in the first chiplet 310 to indicate that a second boot firmware 342 is in a standby state.

The RoT 329 may identify a setting of the register through a second interface 334. In addition, if the second boot firmware 342 is determined to be in the standby state based on the setting of the register, the RoT 329 may load the second boot firmware 342 from the non-volatile memory 340 into the first chiplet 310, and verify the second boot firmware 342. In addition, if verification of the second boot firmware 342 is completed, the RoT 329 may notify the first processor 314a that the verification of the second boot firmware 342 is completed. Then, if notified that the verification of the second boot firmware 342 is completed, the first processor 314a may execute the second boot firmware 342.

If the second boot firmware 342 is executed, the second boot firmware 342 may perform initial hardware setting. Then, the second boot firmware 342 may request loading and verification of a third boot firmware 344 using a mailbox (hereinafter referred to as a second mailbox) 328 of the second chiplet 320 through the second interface 334.

In response to requesting the loading and verification of the third boot firmware 334, the RoT 329 may load the third boot firmware 344 from the non-volatile memory 340 into the first chiplet 310, and verify the third boot firmware 344. In addition, if verification of the third boot firmware 344 is completed, the RoT 329 may notify that the verification of the third boot firmware 344 is completed using a mailbox (hereinafter referred to as a first mailbox) 318 of the first chiplet 310 through the second interface 334. Then, if notified that the verification of the third boot firmware 344 is completed, the first processor 314a may execute the third boot firmware 344.

If the third boot firmware 344 is executed, the third boot firmware 344 may request loading and verification of a fourth firmware 346 (e.g., UCIe firmware) associated with connection setting between the chiplets 310 and 320 using the second mailbox 328 through the second interface 334.

In response to requesting the loading and verification of the fourth firmware 346, the RoT 329 may load the fourth firmware 346 from the non-volatile memory 340 into the first chiplet 310, and verify the fourth firmware 346. Then, if verification of the fourth firmware 346 is completed, the RoT 329 may notify that the verification of the fourth firmware 346 is completed using the first mailbox 318 through the second interface 334.

If notified that the verification of the fourth firmware 346 is completed, the third boot firmware 344 may control a core 316a associated with a first interface 332 to initialize the first interface 332. Then, if initialization of the first interface 332 is completed, the core 316a may notify the first processor 314a that the initialization of the first interface 332 is completed using the first mailbox 318. In addition, the third boot firmware 344 may notify that the initialization of the first interface 332 is completed using the second mailbox 328 through the second interface 334.

If notified that the initialization of the first interface 332 is completed, the processor (hereinafter referred to as a second processor) 324a of the second chiplet 320 may perform a health check of the first interface 332. In addition, if the health check of the first interface 332 is completed, the second processor 324a may notify that the health check of the first interface 332 is completed using the first mailbox 318 through the second interface 334.

If notified that the health check of the first interface 332 is completed, the third boot firmware 344 may perform a health check of the first interface 332. In addition, if the health check of the first interface 332 is completed, the third boot firmware 344 may notify that the health check of the first interface 332 is completed using the second mailbox 328 through the second interface 334.

Then, if the first interface 332 is activated, the third boot firmware 344 may request loading and verification of a fifth firmware 348 (e.g., application firmware) associated with performance of a predetermined function or application using the second mailbox 328 through the first interface 332.

In response to requesting the loading and verification of the fifth firmware 348, the RoT 329 may load the fifth firmware 348 from the non-volatile memory 340 into the first chiplet 310, and verify the fifth firmware 348. Then, if verification of the fifth firmware 348 is completed, the RoT 329 may notify that the verification of the fifth firmware 348 is completed using the first mailbox 318 through the first interface 332. If notified that the verification of the fifth firmware 348 is completed, the first processor 314a may execute the fifth firmware 348.

According to an embodiment, the first boot firmware 312a may be configured to set the register to indicate that a third interface 336 is in a standby state before the register included in the first chiplet 310 is set. The RoT 329 may be configured to identify the setting of the register through the second interface 334. Then, if the third interface 336 is determined to be in the standby state based on the setting of the register, the RoT 329 may be configured to perform clock setting of the first chiplet 310. In addition, the RoT 329 may load a sixth firmware 349 (e.g., PCIe firmware) associated with connection setting with a host device 360 from the non-volatile memory 340 into the first chiplet 310, and verify the sixth firmware 349. Then, if verification of the sixth firmware 349 is completed, the RoT 329 may control the core 316a associated with the third interface 336 to initialize the third interface 336. Then, if initialization of the third interface 336 is completed, the core 316a may notify the RoT 329 that the initialization of the third interface 336 is completed using the second mailbox 328 through the second interface 334.

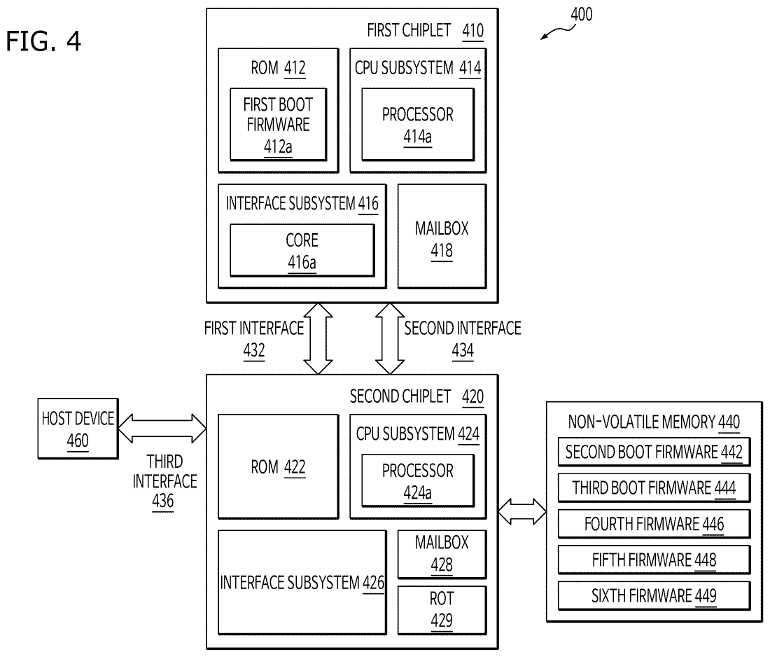

FIG. 4 illustrates a configuration of a chiplet system that performs secure booting of a chiplet not including an RoT, using a chiplet connected to a host device and including an RoT according to an embodiment of the present disclosure. A chiplet system 400 shown in FIG. 4 may be identical or similar to the chiplet system 200 shown in FIG. 2, except that a non-volatile memory 440 in which firmware is stored is not connected to a first chiplet 410 (e.g., the first chiplet 210 of FIG. 2) but connected only to a second chiplet 420 (e.g., the second chiplet 220 of FIG. 2). Accordingly, descriptions for configurations identical or similar to those described with reference to FIG. 2 will be omitted, and a configuration for secure booting in a heterogeneous chiplet system in which an RoT is not included in the first chiplet 410 and an RoT 429 is included in the second chiplet 420 will be described.

Configurations of chiplets 410 and 420 shown in FIG. 4 may be identical or similar to configurations of the chiplets 210 and 220 shown in FIG. 2. For example, the chiplets 410 and 420 may include ROMs 412 and 422 in which first boot firmware (e.g., first boot firmware 412a) is stored, CPU subsystems 414 and 242 including processors 414a and 424a, interface subsystems 416 and 426, and mailboxes 418 and 428. In addition, the second chiplet 420 may be connected to the non-volatile memory 440 in which firmware is stored, and may include an RoT 429. In addition, FIG. 4 shows a configuration associated with the secure booting process of the first chiplet 410, and although not shown, a configuration associated with the secure booting process of the second chiplet 420 may be included in the second chiplet 420. For example, the first boot firmware may be stored in the ROM 422, and the interface subsystem 426 may include a core.

Looking at a secure booting process of the first chiplet 410 using the RoT 429 of the second chiplet 420, the processor (hereinafter referred to as a first processor) 414a of the first chiplet 410 may execute the first boot firmware 412a. Then, if the first boot firmware 412a is executed, the first boot firmware 412a may set a register (not shown) included in the first chiplet 410 to indicate that a second boot firmware 442 is in a standby state.

The RoT 229 may be configured to activate a third interface 236 before identifying a setting of a register included in the first chiplet 210. Then, the RoT 429 may be configured to identify the setting of the register through a second interface 434. In addition, if the second boot firmware 442 is determined to be in the standby state based on the setting of the register, the RoT 429 may load the second boot firmware 442 from the non-volatile memory 440 into the first chiplet 410, and verify the second boot firmware 442. In addition, if verification of the second boot firmware 442 is completed, the RoT 429 may notify the first processor 414a that the verification of the second boot firmware 442 is completed. Then, if notified that the verification of the second boot firmware 442 is completed, the first processor 414a may execute the second boot firmware 442.

If the second boot firmware 442 is executed, the second boot firmware 442 may perform initial hardware setting. Then, the second boot firmware 442 may request loading and verification of a third boot firmware 444 using a mailbox (hereinafter referred to as a second mailbox) 428 of the second chiplet 420 through the second interface 434.

In response to requesting the loading and verification of the third boot firmware 434, the RoT 429 may load the third boot firmware 444 from the non-volatile memory 440 into the first chiplet 410, and verify the third boot firmware 444. In addition, if verification of the third boot firmware 444 is completed, the RoT 429 may notify that the verification of the third boot firmware 444 is completed using a mailbox (hereinafter referred to as a first mailbox) 418 of the first chiplet 410 through the second interface 434. Then, if notified that the verification of the third boot firmware 444 is completed, the first processor 414a may execute the third boot firmware 444.

If the third boot firmware 444 is executed, the third boot firmware 444 may request loading and verification of a fourth firmware 446 (e.g., UCIe firmware) associated with connection setting between the chiplets 410 and 420 using the second mailbox 428 through the second interface 434.

In response to requesting the loading and verification of the fourth firmware 446, the RoT 429 may load the fourth firmware 446 from the non-volatile memory 440 into the first chiplet 410, and verify the fourth firmware 446. Then, if verification of the fourth firmware 446 is completed, the RoT 429 may notify that the verification of the fourth firmware 446 is completed using the first mailbox 418 through the second interface 434.

If notified that the verification of the fourth firmware 446 is completed, the third boot firmware 444 may control a core 416a associated with a first interface 432 to initialize the first interface 432. Then, if initialization of the first interface 432 is completed, the core 416a may notify the first processor 414a that the initialization of the first interface 432 is completed using the first mailbox 418. In addition, the third boot firmware 444 may notify that the initialization of the first interface 432 is completed using the second mailbox 428 through the second interface 434.

If notified that the initialization of the first interface 432 is completed, the processor (hereinafter referred to as a second processor) 424a of the second chiplet 420 may perform a health check of the first interface 432. In addition, if the health check of the first interface 432 is completed, the second processor 424a may notify that the health check of the first interface 432 is completed using the first mailbox 418 through the second interface 434.

If notified that the health check of the first interface 432 is completed, the third boot firmware 444 may perform a health check of the first interface 432. In addition, if the health check of the first interface 432 is completed, the third boot firmware 444 may notify that the health check of the first interface 432 is completed using the second mailbox 428 through the second interface 434.

Then, if the first interface 432 is activated, the third boot firmware 444 may request loading and verification of a fifth firmware 448 (e.g., application firmware) associated with performance of a predetermined function or application using the second mailbox 428 through the first interface 432.

In response to requesting the loading and verification of the fifth firmware 448, the RoT 429 may load the fifth firmware 448 from the non-volatile memory 440 into the first chiplet 410, and verify the fifth firmware 448. Then, if verification of the fifth firmware 448 is completed, the RoT 429 may notify that the verification of the fifth firmware 448 is completed using the first mailbox 418 through the first interface 432. If notified that the verification of the fifth firmware 448 is completed, the first processor 414a may execute the fifth firmware 448.

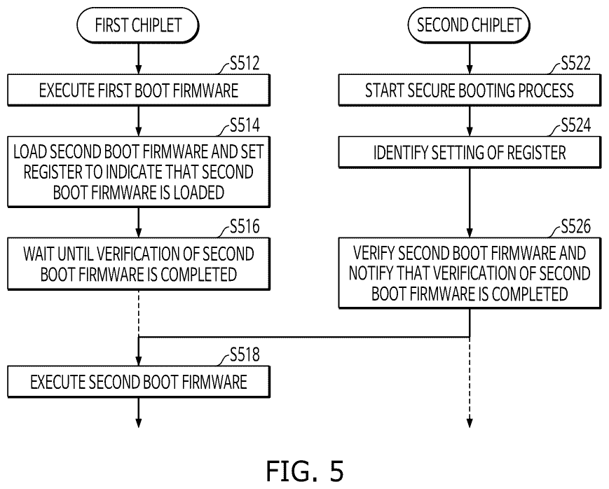

FIG. 5 illustrates a method of verifying and executing a second boot firmware during a secure booting process of a chiplet connected to a non-volatile memory in which boot firmware is stored and not including an RoT, using a chiplet including an RoT according to an embodiment of the present disclosure. Referring to FIG. 5, a first chiplet (e.g., the first chiplet 110 of FIG. 1 or the first chiplet 210 of FIG. 2) not including an RoT and connected to a non-volatile memory in which firmware is stored may execute first boot firmware (e.g., ZSBL) in step S512. For example, if power is supplied to a chiplet system (e.g., the chiplet system 100 of FIG. 1 or the chiplet system 200 of FIG. 2) and signals associated with booting (e.g., a boot signal, a reset signal, etc.) are received, a processor of the first chiplet may execute the first boot firmware.

In step S514, the first chiplet may load second boot firmware (e.g., FSBL), and set a register to indicate that the second boot firmware is being loaded. For example, if the first boot firmware is executed, the first boot firmware may load the second boot firmware from the non-volatile memory, and set a register included in the first chiplet to indicate that the second boot firmware is loaded.

In step S516, the first chiplet may wait until verification of the second boot firmware is completed.

Meanwhile, a second chiplet (e.g., the second chiplet 120 of FIG. 1 or the second chiplet 220 of FIG. 2) including an RoT may start a secure booting process in step S522. For example, if power is supplied to the chiplet system and signals associated with booting are received, an RoT of the second chiplet may start the secure booting process.

In step S524, the second chiplet may identify a setting of the register. For example, the RoT of the second chiplet may identify the setting of the register through a second interface. Here, the second interface is an interface for connection between chiplets, and may be a backup interface whose data communication speed is set lower than a first interface. For example, the second interface may include an SPI interface.

In step S526, the second chiplet may verify the second boot firmware and notify that the verification of the second boot firmware is completed. For example, if the second boot firmware is determined to be loaded based on the setting of the register, the RoT of the second chiplet may verify the second boot firmware. In addition, if verification of the second boot firmware is completed, the RoT of the second chiplet may notify the processor of the first chiplet that the verification of the second boot firmware is completed.

In step S518, the first chiplet may execute the second boot firmware. For example, if notified that the verification of the second boot firmware is completed, the processor of the first chiplet may execute the second boot firmware.

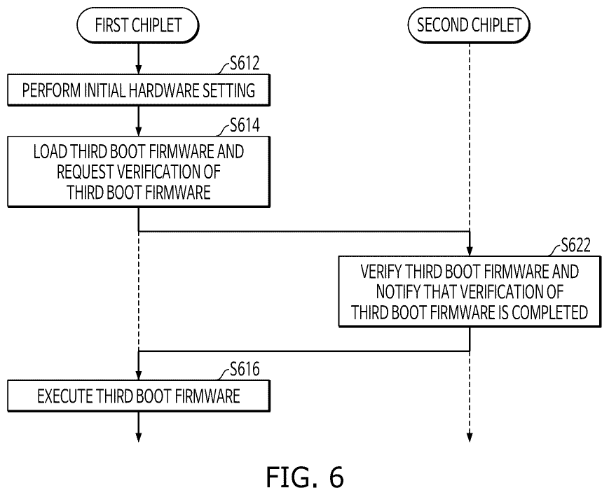

FIG. 6 illustrates a method of verifying and executing a third boot firmware during a secure booting process of a chiplet connected to a non-volatile memory in which boot firmware is stored and not including an RoT, using a chiplet including an RoT according to an embodiment of the present disclosure. Referring to FIG. 6, a first chiplet (e.g., the first chiplet 110 of FIG. 1 or the first chiplet 210 of FIG. 2) not including an RoT and connected to a non-volatile memory in which firmware is stored may perform initial hardware setting in step S612. For example, if second boot firmware is executed, the second boot firmware may perform initial hardware setting. According to an embodiment, the second boot firmware may perform a PLL setting for adjusting a clock frequency. Accordingly, high-speed operation of the chiplet may be possible.

In step S614, the first chiplet may load third boot (e.g., SSBL) firmware and request verification of the third boot firmware. For example, the second boot firmware may load the third boot firmware from the non-volatile memory, and request verification of the third boot firmware using a mailbox of a second chiplet through a second interface. Here, the second interface is an interface for connection between chiplets, and may be a backup interface whose data communication speed is set lower than a first interface. For example, the second interface may include an SPI interface.

In step S622, a second chiplet (e.g., the second chiplet 120 of FIG. 1 or the second chiplet 220 of FIG. 2) including an RoT may verify the third boot firmware and notify that verification of the third boot firmware is completed. For example, in response to requesting the verification of the third boot firmware, an RoT of the second chiplet may verify the third boot firmware. In addition, if verification of the third boot firmware is completed, the RoT of the second chiplet may notify that the verification of the third boot firmware is completed using a mailbox of the first chiplet through the second interface.

In step S616, the first chiplet may execute the third boot firmware. For example, if notified that the verification of the third boot firmware is completed, the processor of the first chiplet may execute the third boot firmware.

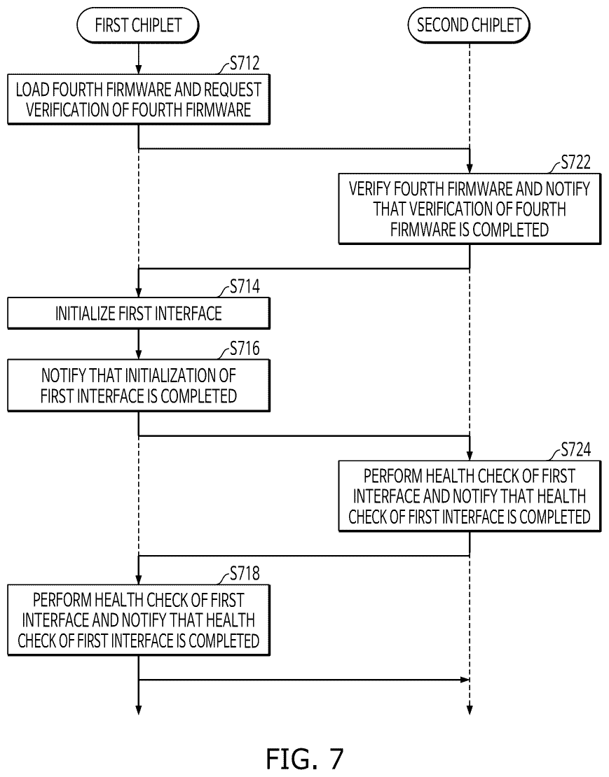

FIG. 7 illustrates a method of verifying and executing a fourth firmware associated with connection setting between chiplets during a secure booting process of a chiplet connected to a non-volatile memory in which boot firmware is stored and not including an RoT, using a chiplet including an RoT according to an embodiment of the present disclosure. Referring to FIG. 7, a first chiplet (e.g., the first chiplet 110 of FIG. 1 or the first chiplet 210 of FIG. 2) not including an RoT and connected to a non-volatile memory in which firmware is stored may load fourth firmware and request verification of the fourth firmware in step S712. For example, if third boot firmware is executed, the third boot firmware may load fourth firmware (e.g., UCIe firmware) associated with connection setting between chiplets from the non-volatile memory, and request verification of the fourth firmware using a mailbox of a second chiplet through a second interface. Here, the second interface is an interface for connection between chiplets, and may be a backup interface whose data communication speed is set lower than a first interface. For example, the second interface may include an SPI interface.

In step S722, a second chiplet (e.g., the second chiplet 120 of FIG. 1 or the second chiplet 220 of FIG. 2) including an RoT may verify the fourth firmware and notify that verification of the fourth firmware is completed. For example, in response to requesting the verification of the fourth firmware, an RoT of the second chiplet may verify the fourth firmware. In addition, if verification of the fourth firmware is completed, the RoT of the second chiplet may notify that the verification of the fourth firmware is completed using a mailbox of the first chiplet through the second interface.

In step S714, the first chiplet may initialize a first interface. For example, if notified that the verification of the fourth firmware is completed, the third boot firmware may control a core associated with the first interface to initialize the first interface. Here, the first interface is an interface for connection between chiplets, and for example, may include a UCIe interface.

In step S716, the first chiplet may notify that initialization of the first interface is completed. For example, if initialization of the first interface is completed, a core of the first chiplet may notify a processor of the first chiplet that the initialization of the first interface is completed using a mailbox of the first chiplet. In addition, the third boot firmware may notify that the initialization of the first interface is completed using a mailbox of the second chiplet through the second interface.

In step S724, the second chiplet may perform a health check of the first interface and notify that the health check of the first interface is completed. For example, if notified that the initialization of the first interface is completed, a processor of the second chiplet may perform a health check of the first interface. In addition, if the health check of the first interface is completed, the processor of the second chiplet may notify that the health check of the first interface is completed using the mailbox of the first chiplet through the second interface.

In step S718, the first chiplet may perform a health check of the first interface and notify that the health check of the first interface is completed. For example, if notified that the health check of the first interface is completed, the third boot firmware may perform a health check of the first interface. In addition, if the health check of the first interface is completed, the third boot firmware may notify that the health check of the first interface is completed using the mailbox of the second chiplet through the second interface.

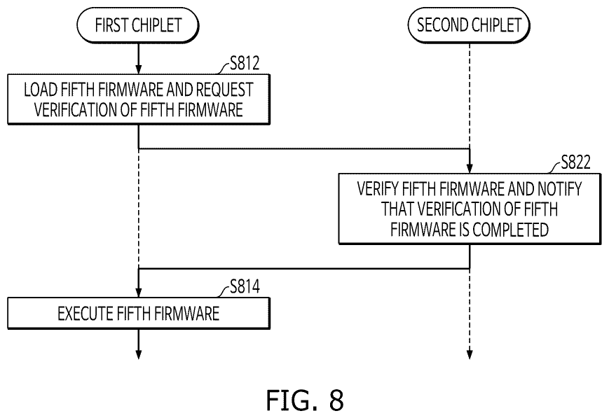

FIG. 8 illustrates a method of verifying and executing a fifth firmware associated with performance of a predetermined function or application during a secure booting process of a chiplet connected to a non-volatile memory in which boot firmware is stored and not including an RoT, using a chiplet including an RoT according to an embodiment of the present disclosure. Referring to FIG. 8, a first chiplet (e.g., the first chiplet 110 of FIG. 1 or the first chiplet 210 of FIG. 2) not including an RoT and connected to a non-volatile memory in which firmware is stored may load fifth firmware and request verification of the fifth firmware in step S812. For example, if a first interface is activated, third boot firmware may load fifth firmware (e.g., application firmware) associated with performance of a predetermined function or application from the non-volatile memory, and request verification of the fifth firmware using a mailbox of a second chiplet through the first interface. Here, the first interface is an interface for connection between chiplets, and for example, may include a UCIe interface.

In step S822, a second chiplet (e.g., the second chiplet 120 of FIG. 1 or the second chiplet 220 of FIG. 2) including an RoT may verify the fifth firmware and notify that verification of the fifth firmware is completed. For example, in response to requesting the verification of the fifth firmware, an RoT of the second chiplet may verify the fifth firmware. In addition, if verification of the fifth firmware is completed, the RoT of the second chiplet may notify that the verification of the fifth firmware is completed using a mailbox of the first chiplet through the first interface.

In step S814, the first chiplet may execute the fifth firmware. For example, if notified that the verification of the fifth firmware is completed, a processor of the first chiplet may execute the fifth firmware 148.

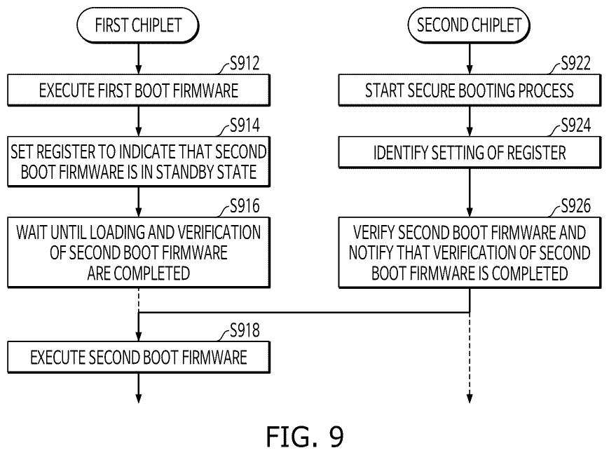

FIG. 9 illustrates a method of verifying and executing a second boot firmware during a secure booting process of a chiplet not including an RoT, using a chiplet connected to a non-volatile memory in which boot firmware is stored and including an RoT according to an embodiment of the present disclosure. Referring to FIG. 9, a first chiplet (e.g., the first chiplet 310 of FIG. 3 or the first chiplet 410 of FIG. 4) not including an RoT and not connected to a non-volatile memory in which firmware is stored may execute first boot firmware (e.g., ZSBL) in step S912. For example, if power is supplied to a chiplet system (e.g., the chiplet system 300 of FIG. 3 or the chiplet system 400 of FIG. 4) and signals associated with booting (e.g., a boot signal, a reset signal, etc.) are received, a processor of the first chiplet may execute the first boot firmware.

In step S914, the first chiplet may set a register to indicate that second boot firmware (e.g., FSBL) is in a standby state. For example, if the first boot firmware is executed, the first boot firmware may set a register included in the first chiplet to indicate that the second boot firmware is in the standby state.

In step S916, the first chiplet may wait until loading and verification of the second boot firmware are completed.

Meanwhile, a second chiplet (e.g., the second chiplet 320 of FIG. 3 or the second chiplet 420 of FIG. 4) including an RoT and connected to a non-volatile memory in which firmware is stored may start a secure booting process in step S922. For example, if power is supplied to the chiplet system and signals associated with booting are received, an RoT of the second chiplet may start the secure booting process.

In step S924, the second chiplet may identify a setting of the register. For example, the RoT of the second chiplet may identify the setting of the register through a second interface. Here, the second interface is an interface for connection between chiplets, and may be a backup interface whose data communication speed is set lower than a first interface. For example, the second interface may include an SPI interface.

In step S926, the second chiplet may load and verify the second boot firmware and notify that the verification of the second boot firmware is completed. For example, if the second boot firmware is determined to be in the standby state based on the setting of the register, the RoT of the second chiplet may load the second boot firmware from the non-volatile memory into the first chiplet, and verify the second boot firmware. In addition, if verification of the second boot firmware is completed, the RoT of the second chiplet may notify the processor of the first chiplet that the verification of the second boot firmware is completed.

In step S918, the first chiplet may execute the second boot firmware. For example, if notified that the verification of the second boot firmware is completed, the processor of the first chiplet may execute the second boot firmware.

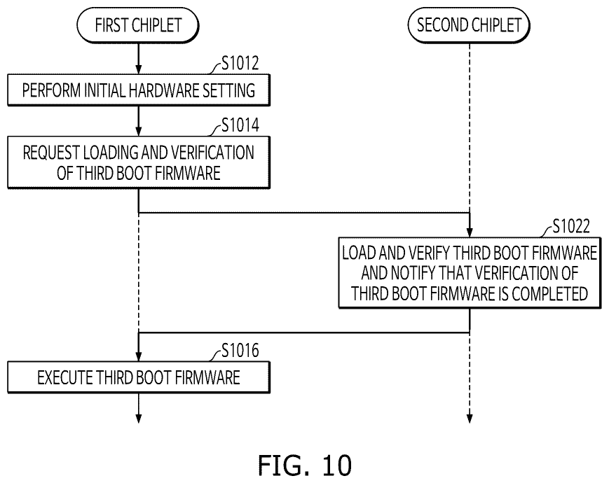

FIG. 10 illustrates a method of verifying and executing a third boot firmware during a secure booting process of a chiplet not including an RoT, using a chiplet connected to a non-volatile memory in which boot firmware is stored and including an RoT according to an embodiment of the present disclosure. Referring to FIG. 10, a first chiplet (e.g., the first chiplet 310 of FIG. 3 or the first chiplet 410 of FIG. 4) not including an RoT and not connected to a non-volatile memory in which firmware is stored may perform initial hardware setting in step S1012. For example, if second boot firmware is executed, the second boot firmware may perform initial hardware setting. According to an embodiment, the second boot firmware may perform a PLL setting for adjusting a clock frequency. Accordingly, high-speed operation of the chiplet may be possible.

In step S1014, the first chiplet may request loading and verification of third boot (e.g., SSBL) firmware. For example, the second boot firmware may request loading and verification of the third boot firmware using a mailbox of a second chiplet through a second interface. Here, the second interface is an interface for connection between chiplets, and may be a backup interface whose data communication speed is set lower than a first interface. For example, the second interface may include an SPI interface.

In step S1022, a second chiplet (e.g., the second chiplet 320 of FIG. 3 or the second chiplet 420 of FIG. 4) including an RoT and connected to a non-volatile memory in which firmware is stored may load and verify the third boot firmware and notify that verification of the third boot firmware is completed. For example, in response to requesting the loading and verification of the third boot firmware, an RoT of the second chiplet may load the third boot firmware from the non-volatile memory into the first chiplet, and verify the third boot firmware. In addition, if verification of the third boot firmware is completed, the RoT of the second chiplet may notify that the verification of the third boot firmware is completed using a mailbox of the first chiplet through the second interface.

In step S1016, the first chiplet may execute the third boot firmware. For example, if notified that the verification of the third boot firmware is completed, the processor of the first chiplet may execute the third boot firmware.

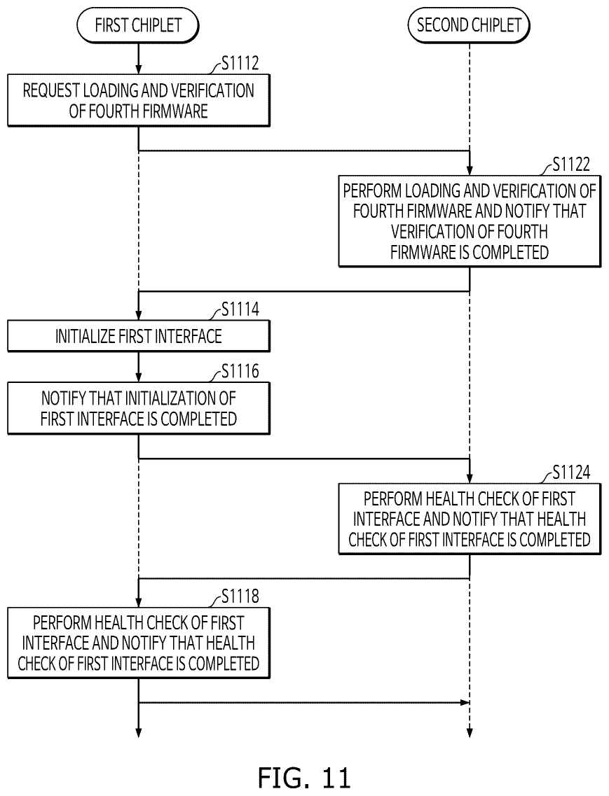

FIG. 11 illustrates a method of verifying and executing a fourth firmware associated with connection setting between chiplets during a secure booting process of a chiplet not including an RoT, using a chiplet connected to a non-volatile memory in which boot firmware is stored and including an RoT according to an embodiment of the present disclosure. Referring to FIG. 11, a first chiplet (e.g., the first chiplet 310 of FIG. 3 or the first chiplet 410 of FIG. 4) not including an RoT and not connected to a non-volatile memory in which firmware is stored may request loading and verification of fourth firmware in step S1112. For example, if third boot firmware is executed, the third boot firmware may request loading and verification of fourth firmware (e.g., UCIe firmware) associated with connection setting between chiplets using a mailbox of a second chiplet through a second interface. Here, the second interface is an interface for connection between chiplets, and may be a backup interface whose data communication speed is set lower than a first interface. For example, the second interface may include an SPI interface.

In step S1122, a second chiplet (e.g., the second chiplet 320 of FIG. 3 or the second chiplet 420 of FIG. 4) including an RoT and connected to a non-volatile memory in which firmware is stored may perform loading and verification of the fourth firmware and notify that verification of the fourth firmware is completed. For example, in response to requesting the loading and verification of the fourth firmware, an RoT of the second chiplet may load the fourth firmware from the non-volatile memory into the first chiplet, and verify the fourth firmware. Then, if verification of the fourth firmware is completed, the RoT of the second chiplet may notify that the verification of the fourth firmware is completed using a mailbox of the first chiplet through the second interface.

In step S1114, the first chiplet may initialize a first interface. For example, if notified that the verification of the fourth firmware is completed, the third boot firmware may control a core associated with the first interface to initialize the first interface. Here, the first interface is an interface for connection between chiplets, and for example, may include a UCIe interface.

In step S1116, the first chiplet may notify that initialization of the first interface is completed. For example, if initialization of the first interface is completed, a core of the first chiplet may notify a processor of the first chiplet that the initialization of the first interface is completed using a mailbox of the first chiplet. In addition, the third boot firmware may notify that the initialization of the first interface is completed using the mailbox of the second chiplet through the second interface.

In step S1124, the second chiplet may perform a health check of the first interface and notify that the health check of the first interface is completed. For example, if notified that the initialization of the first interface is completed, a processor of the second chiplet may perform a health check of the first interface. In addition, if the health check of the first interface is completed, the processor of the second chiplet may notify that the health check of the first interface is completed using the mailbox of the first chiplet through the second interface.

In step S1118, the first chiplet may perform a health check of the first interface and notify that the health check of the first interface is completed. For example, if notified that the health check of the first interface is completed, the third boot firmware may perform a health check of the first interface. In addition, if the health check of the first interface is completed, the third boot firmware may notify that the health check of the first interface is completed using the mailbox of the second chiplet through the second interface.

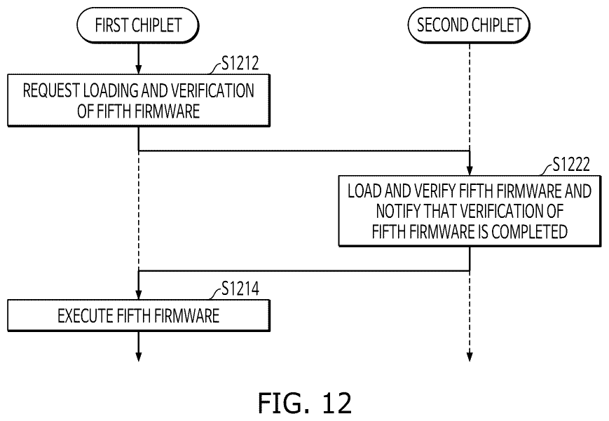

FIG. 12 illustrates a method of verifying and executing a fifth firmware associated with performance of a predetermined function or application during a secure booting process of a chiplet not including an RoT, using a chiplet connected to a non-volatile memory in which boot firmware is stored and including an RoT according to an embodiment of the present disclosure. Referring to FIG. 12, a first chiplet (e.g., the first chiplet 310 of FIG. 3 or the first chiplet 410 of FIG. 4) not including an RoT and not connected to a non-volatile memory in which firmware is stored may request loading and verification of fifth firmware in step S1212. For example, if a first interface is activated, third boot firmware may request loading and verification of fifth firmware (e.g., application firmware) associated with performance of a predetermined function or application using a mailbox of a second chiplet through the first interface. Here, the first interface is an interface for connection between chiplets, and for example, may include a UCIe interface.

In step S1222, a second chiplet (e.g., the second chiplet 320 of FIG. 3 or the second chiplet 420 of FIG. 4) including an RoT and connected to a non-volatile memory in which firmware is stored may load and verify the fifth firmware and notify that verification of the fifth firmware is completed. For example, in response to requesting the loading and verification of the fifth firmware, an RoT of the second chiplet may load the fifth firmware and verify the fifth firmware. In addition, if verification of the fifth firmware is completed, the RoT of the second chiplet may notify that the verification of the fifth firmware is completed using a mailbox of the first chiplet through the first interface.

In step S1214, the first chiplet may execute the fifth firmware. For example, if notified that the verification of the fifth firmware is completed, the processor of the first chiplet may execute the fifth firmware.

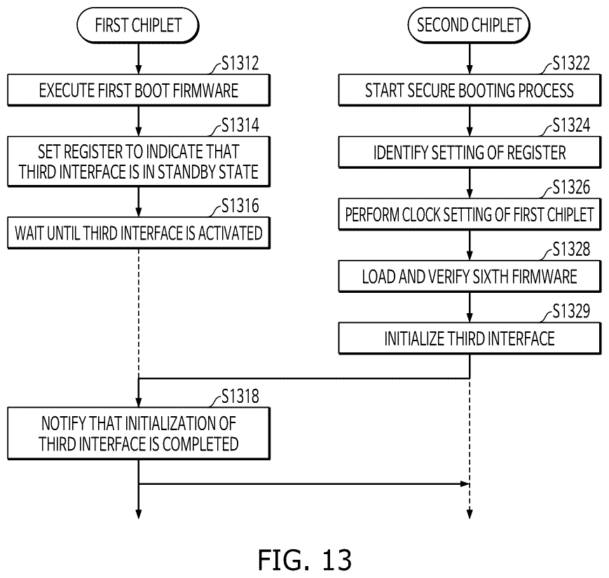

FIG. 13 illustrates a method of initializing an interface with a host device during a secure booting process of a chiplet connected to the host device and not including an RoT, using a chiplet including an RoT according to an embodiment of the present disclosure. Referring to FIG. 13, a first chiplet (e.g., the first chiplet 110 of FIG. 1 or the first chiplet 310 of FIG. 3) not including an RoT and connected to a host device may execute first boot firmware (e.g., ZSBL) in step S1312. For example, if power is supplied to a chiplet system (e.g., the chiplet system 100 of FIG. 1 or the chiplet system 300 of FIG. 3) and signals associated with booting (e.g., a boot signal, a reset signal, etc.) are received, a processor of the first chiplet may execute the first boot firmware.

In step S1314, the first chiplet may set a register to indicate that a third interface is in a standby state. For example, the first boot firmware may set a register included in the first chiplet to indicate that the third interface is in the standby state. Here, the third interface is an interface for connection with the host device, and for example, may include a PCIe interface.

In step S1316, the first chiplet may wait until the third interface is activated.

Meanwhile, a second chiplet (e.g., the second chiplet 120 of FIG. 1 or the second chiplet 320 of FIG. 3) including an RoT and not connected to the host device may start a secure booting process in step S1322. For example, if power is supplied to the chiplet system and signals associated with booting are received, an RoT of the second chiplet may start the secure booting process.

In step S1324, the second chiplet may identify a setting of the register. For example, the RoT of the second chiplet may identify the setting of the register through a second interface. Here, the second interface is an interface for connection between chiplets, and may be a backup interface whose data communication speed is set lower than a first interface. For example, the second interface may include an SPI interface.

In step S1326, the second chiplet may perform clock setting of the first chiplet. For example, if the third interface is determined to be in the standby state based on the setting of the register, the RoT of the second chiplet may perform clock setting of the first chiplet.

In step S1328, the second chiplet may load and verify a sixth firmware. For example, the RoT of the second chiplet may load a sixth firmware (e.g., PCIe firmware) associated with connection setting with the host device from a non-volatile memory into the first chiplet, and verify the sixth firmware.

In step S1329, the second chiplet may initialize the third interface. For example, if verification of the sixth firmware is completed, the RoT of the second chiplet may control a core associated with the third interface to initialize the third interface.

In step S1318, the first chiplet may notify that initialization of the third interface is completed. For example, if initialization of the third interface is completed, a core of the first chiplet may notify the RoT of the second chiplet that the initialization of the third interface is completed using a mailbox of the second chiplet through the second interface.

The flowcharts and descriptions described above are merely examples, and may be implemented differently in some embodiments. For example, in some embodiments, the order of each step may be changed, some steps may be performed repeatedly, some steps may be omitted, or some steps may be added.

The methods described above may be provided as a computer program stored in a computer-readable recording medium for execution on a computer. The medium may continuously store programs executable by a computer, or temporarily store them for execution or download. In addition, the medium may be various recording means or storage means in a form where a single or several pieces of hardware are combined, and is not limited to a medium directly connected to a certain computer system, but may exist distributed on a network. Examples of the medium may include magnetic media such as a hard disk, a floppy disk, and a magnetic tape, optical recording media such as a CD-ROM and a DVD, magneto-optical media such as a floptical disk, and those configured to store program instructions including ROM, RAM, flash memory, and the like. In addition, as other examples of the medium, recording media or storage media managed by an app store that distributes applications or sites, servers, etc. that supply or distribute various other software can also be mentioned.

The methods, operations, or techniques of the present disclosure may be implemented by various means. For example, these techniques may be implemented in hardware, firmware, software, or combinations thereof. Those skilled in the art will understand that various exemplary logical blocks, modules, circuits, and algorithm steps described in connection with the disclosure herein may be implemented as electronic hardware, computer software, or combinations of both. To clearly illustrate this interchangeability of hardware and software, various exemplary components, blocks, modules, circuits, and steps have been described above generally in terms of their functionality. Whether such functionality is implemented as hardware or software depends upon specific applications and design requirements imposed on the overall system. Those skilled in the art may implement the described functionality in various ways for each specific application, but such implementations should not be interpreted as causing a departure from the scope of the present disclosure.

In a hardware implementation, processing units used to perform the techniques may be implemented within one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, a computer, or combinations thereof.

Accordingly, various exemplary logical blocks, modules, and circuits described in connection with the present disclosure may be implemented or performed with a general-purpose processor, a DSP, an ASIC, an FPGA or other programmable logic device, discrete gate or transistor logic, discrete hardware components, or any combination of those designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in connection with a DSP core, or any other combination of configurations.

In firmware and/or software implementations, techniques may be implemented as instructions stored on a computer-readable medium such as random access memory (RAM), read-only memory (ROM), non-volatile random access memory (NVRAM), programmable read-only memory (PROM), erasable programmable read-only memory (EPROM), electrically erasable PROM (EEPROM), flash memory, a compact disc (CD), a magnetic or optical data storage device, and the like. Instructions may be executable by one or more processors and may cause the processor(s) to perform specific aspects of functionality described in the present disclosure.

If implemented in software, the techniques described above may be stored on or transmitted through a computer-readable medium as one or more instructions or code. Computer-readable media include both computer storage media and communication media including any medium that facilitates transfer of a computer program from one place to another. Storage media may be any available media that can be accessed by a computer. By way of non-limiting example, such computer-readable media may include RAM, ROM, EEPROM, CD-ROM or other optical disk storage, magnetic disk storage or other magnetic storage devices, or any other medium that can be used to transfer or store desired program code in the form of instructions or data structures and that can be accessed by a computer. In addition, any connection is properly termed a computer-readable medium.

For example, if software is transmitted from a website, server, or other remote source using coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included within the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of the above should also be included within the scope of computer-readable media.

A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to a processor such that the processor can read information from the storage medium or write information to the storage medium. In the alternative, the storage medium may be integrated into the processor. The processor and the storage medium may reside in an ASIC. The ASIC may reside in a user terminal. In the alternative, the processor and the storage medium may reside as discrete components in the user terminal.

Although the embodiments described above have been described as utilizing aspects of the currently disclosed subject matter in one or more standalone computer systems, the present disclosure is not limited thereto and may be implemented in connection with any computing environment such as a network or distributed computing environment. Furthermore, aspects of the subject matter in the present disclosure may be implemented in a plurality of processing chips or devices, and storage may similarly be affected across a plurality of devices. Such devices may include PCs, network servers, and portable devices.

Although the present disclosure has been described in connection with some embodiments in this specification, various modifications and changes can be made within the scope not departing from the scope of the present disclosure that can be understood by those of ordinary skill in the technical field to which the invention of the present disclosure belongs. In addition, such modifications and changes should be considered to fall within the scope of the claims attached to this specification.

1. A chiplet system comprising a plurality of chiplets, the chiplet system comprising:
a first chiplet including a ROM (read-only memory) in which a first boot firmware is stored and a first processor, the first chiplet being connected to a non-volatile memory in which a second boot firmware is stored;
a second chiplet including an RoT (root of trust) in which immutable data is stored and a second processor;
a first interface connecting the first chiplet and the second chiplet; and
a second interface connecting the first chiplet and the second chiplet, a communication speed of the second interface being set lower than a communication speed of the first interface,
wherein the first processor is configured to execute the first boot firmware,
wherein if the first boot firmware is executed, the first boot firmware is configured to:
load the second boot firmware from the non-volatile memory; and
set a register included in the first chiplet to indicate that the second boot firmware is loaded,
wherein the RoT is configured to:
before initialization of the first interface, identify a setting of the register through the second interface;
verify the second boot firmware if the second boot firmware is determined to be loaded based on the setting of the register; and
notify the first processor that verification of the second boot firmware is completed if the verification of the second boot firmware is completed, and
wherein if notified that the verification of the second boot firmware is completed, the first processor is further configured to execute the second boot firmware.

2. The chiplet system as claimed in claim 1, wherein the non-volatile memory further stores a third boot firmware,
wherein the first chiplet further includes a first mailbox,
wherein the second chiplet further includes a second mailbox,
wherein if the second boot firmware is executed, the second boot firmware is configured to:
perform initial hardware setting;
load the third boot firmware from the non-volatile memory; and
request verification of the third boot firmware using the second mailbox through the second interface,
wherein in response to requesting the verification of the third boot firmware, the RoT is further configured to verify the third boot firmware; and
if verification of the third boot firmware is completed, notify that the verification of the third boot firmware is completed using the first mailbox through the second interface, and
wherein if notified that the verification of the third boot firmware is completed, the first processor is further configured to execute the third boot firmware.

3. The chiplet system as claimed in claim 2, wherein the initial hardware setting includes a phase-locked loop (PLL) setting for adjusting a clock frequency.

4. The chiplet system as claimed in claim 2, wherein the non-volatile memory further stores a fourth firmware associated with connection setting between chiplets,
wherein if the third boot firmware is executed, the third boot firmware is configured to:
load the fourth firmware from the non-volatile memory; and
request verification of the fourth firmware using the second mailbox through the second interface,
wherein in response to requesting the verification of the fourth firmware, the RoT is further configured to:
verify the fourth firmware; and
if verification of the fourth firmware is completed, notify that the verification of the fourth firmware is completed using the first mailbox through the second interface,
wherein if notified that the verification of the fourth firmware is completed, the third boot firmware is further configured to control a core associated with the first interface to initialize the first interface,
wherein if the initialization of the first interface is completed, the core is configured to notify the first processor that the initialization of the first interface is completed using the first mailbox, and
wherein the third boot firmware is further configured to notify that the initialization of the first interface is completed using the second mailbox through the second interface.

5. The chiplet system as claimed in claim 4, wherein if notified that the initialization of the first interface is completed, the second processor is configured to:
perform a health check of the first interface; and
if the health check of the first interface is completed, notify that the health check of the first interface is completed using the first mailbox through the second interface, and
wherein if notified that the health check of the first interface is completed, the third boot firmware is further configured to:
perform a health check of the first interface; and
if the health check of the first interface is completed, notify that the health check of the first interface is completed using the second mailbox through the second interface.

6. The chiplet system as claimed in claim 4, wherein the non-volatile memory further stores a fifth firmware associated with performance of a predetermined function or application,
wherein if the first interface is activated, the third boot firmware is further configured to:
load the fifth firmware from the non-volatile memory; and
request verification of the fifth firmware using the second mailbox through the first interface,
wherein in response to requesting the verification of the fifth firmware, the RoT is further configured to:
verify the fifth firmware; and
if verification of the fifth firmware is completed, notify that the verification of the fifth firmware is completed using the first mailbox through the first interface, and
wherein if notified that the verification of the fifth firmware is completed, the first processor is further configured to execute the fifth firmware.

7. The chiplet system as claimed in claim 1, further comprising a third interface connecting the second chiplet and a host device,
wherein the RoT is further configured to activate the third interface before identifying the setting of the register.

8. The chiplet system as claimed in claim 1, further comprising a third interface connecting the first chiplet and a host device,
wherein the non-volatile memory further stores a sixth firmware associated with connection setting with the host device,
wherein the first boot firmware is further configured to set the register to indicate that the third interface is in a standby state before loading the second boot firmware,
wherein the RoT is further configured to:
identify the setting of the register through the second interface;
perform clock setting of the first chiplet if the third interface is determined to be in the standby state based on the setting of the register;
load the sixth firmware from the non-volatile memory;
verify the sixth firmware; and
if verification of the sixth firmware is completed, control a core associated with the third interface to initialize the third interface, and
wherein if initialization of the third interface is completed, the core is configured to notify the RoT that the initialization of the third interface is completed using a mailbox included in the second chiplet through the second interface.

9. The chiplet system as claimed in claim 8, wherein the third interface includes a peripheral component interconnect express (PCIe) interface.

10. The chiplet system as claimed in claim 1, wherein the first interface includes a universal chiplet interconnect express (UCIe) interface, and the second interface includes a serial peripheral interface (SPI) interface.

11. A chiplet system comprising a plurality of chiplets, the chiplet system comprising:
a first chiplet including a ROM (read-only memory) in which a first boot firmware is stored and a first processor;
a second chiplet including an RoT (root of trust) in which immutable data is stored and a second processor, the second chiplet being connected to a non-volatile memory in which a second boot firmware is stored;
a first interface connecting the first chiplet and the second chiplet; and
a second interface connecting the first chiplet and the second chiplet, a communication speed of the second interface being set lower than a communication speed of the first interface,
wherein the first processor is configured to execute the first boot firmware,
wherein if the first boot firmware is executed, the first processor is further configured to set a register included in the first chiplet to indicate that the second boot firmware is in a standby state,
wherein the RoT is configured to:
before initialization of the first interface, identify a setting of the register through the second interface;
load the second boot firmware from the non-volatile memory into the first chiplet if the second boot firmware is determined to be in the standby state based on the setting of the register;
verify the second boot firmware; and
notify the first processor that verification of the second boot firmware is completed if the verification of the second boot firmware is completed, and
wherein if notified that the verification of the second boot firmware is completed, the first processor is further configured to execute the second boot firmware.

12. The chiplet system as claimed in claim 11, wherein the non-volatile memory further stores a third boot firmware,
wherein the first chiplet further includes a first mailbox,
wherein the second chiplet further includes a second mailbox,
wherein if the second boot firmware is executed, the second boot firmware is configured to:
perform initial hardware setting; and
request loading and verification of the third boot firmware using the second mailbox through the second interface,
wherein in response to requesting the loading and verification of the third boot firmware, the RoT is further configured to:
load the third boot firmware from the non-volatile memory into the first chiplet;
verify the third boot firmware; and
if verification of the third boot firmware is completed, notify that the verification of the third boot firmware is completed using the first mailbox through the second interface, and
wherein if notified that the verification of the third boot firmware is completed, the first processor is further configured to execute the third boot firmware.

13. The chiplet system as claimed in claim 12, wherein the initial hardware setting includes a phase-locked loop (PLL) setting for adjusting a clock frequency.

14. The chiplet system as claimed in claim 12, wherein the non-volatile memory further stores a fourth firmware associated with connection setting between chiplets,
wherein if the third boot firmware is executed, the third boot firmware is configured to request loading and verification of the fourth firmware using the second mailbox through the second interface,
wherein in response to requesting the loading and verification of the fourth firmware, the RoT is further configured to:
load the fourth firmware from the non-volatile memory into the first chiplet;
verify the fourth firmware; and
if verification of the fourth firmware is completed, notify that the verification of the fourth firmware is completed using the first mailbox through the second interface,
wherein if notified that the verification of the fourth firmware is completed, the third boot firmware is further configured to control a core associated with the first interface to initialize the first interface,
wherein if the initialization of the first interface is completed, the core is configured to notify the first processor that the initialization of the first interface is completed using the first mailbox, and
wherein the third boot firmware is further configured to notify that the initialization of the first interface is completed using the second mailbox through the second interface.

15. The chiplet system as claimed in claim 14, wherein if notified that the initialization of the first interface is completed, the second processor is configured to:
perform a health check of the first interface; and
if the health check of the first interface is completed, notify that the health check of the first interface is completed using the first mailbox through the second interface, and
wherein if notified that the health check of the first interface is completed, the third boot firmware is further configured to:
perform a health check of the first interface; and
if the health check of the first interface is completed, notify that the health check of the first interface is completed using the second mailbox through the second interface.

16. The chiplet system as claimed in claim 14, wherein the non-volatile memory further stores a fifth firmware associated with performance of a predetermined function or application,
wherein if the first interface is activated, the third boot firmware is further configured to request loading and verification of the fifth firmware using the second mailbox through the first interface,
wherein in response to requesting the loading and verification of the fifth firmware, the RoT is further configured to:
load the fifth firmware from the non-volatile memory into the first chiplet;
verify the fifth firmware; and
if verification of the fifth firmware is completed, notify that the verification of the fifth firmware is completed using the first mailbox through the first interface, and
wherein if notified that the verification of the fifth firmware is completed, the first processor is further configured to execute the fifth firmware.

17. The chiplet system as claimed in claim 11, further comprising a third interface connecting the second chiplet and a host device,
wherein the RoT is further configured to activate the third interface before identifying the setting of the register.

18. The chiplet system as claimed in claim 11, further comprising a third interface connecting the first chiplet and a host device,
wherein the non-volatile memory further stores a sixth firmware associated with connection setting with the host device,
wherein the first boot firmware is further configured to set the register to indicate that the third interface is in a standby state before the register is set,
wherein the RoT is further configured to:
identify the setting of the register through the second interface;
perform clock setting of the first chiplet if the third interface is determined to be in the standby state based on the setting of the register;
load the sixth firmware from the non-volatile memory into the first chiplet; and
verify the sixth firmware,
wherein if verification of the sixth firmware is completed, the RoT is further configured to control a core associated with the third interface to initialize the third interface, and
wherein if initialization of the third interface is completed, the core is configured to notify the RoT that the initialization of the third interface is completed using a mailbox included in the second chiplet through the second interface.

19. The chiplet system as claimed in claim 18, wherein the third interface includes a peripheral component interconnect express (PCIe) interface.

20. The chiplet system as claimed in claim 11, wherein the first interface includes a universal chiplet interconnect express (UCIe) interface, and the second interface includes a serial peripheral interface (SPI) interface.
